(19) United States
(12) Patent Application Publication
(10) Pub. No.: US 2008/0152422 A1
(43) Pub. Date: Jun. 26, 2008

(54) SHAFT-HUB CONNECTION AND USE OF A SHAFT-HUB CONNECTION FOR FASTENING A GRINDING TOOL ON A GRINDING TOOL DRIVESHAFT

(75) Inventor: Gerd EISENBLAETTER, Geretsried (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: GERD EISENBLATTER GmbH

(21) Appl. No.: 11/938,649

(22) Filed: Nov. 12, 2007

(30) Foreign Application Priority Data
May 11, 2005 (DE) DE 102005021833.4

(51) Int. Cl. F16D 1/06

(52) U.S. Cl. 403/1; 403/409.1

(57) ABSTRACT

The present invention relates to a shaft-hub connection for fastening a grinding tool on a grinding tool driveshaft and the use of a shaft-hub connection for fastening a grinding tool on a grinding tool driveshaft. To simplify the mounting of a grinding tool on a grinding tool driveshaft, the peripheral surface of the shaft or the internal surface of the grinding tool hub has a number of circular wedge faces and the other of the two components has a number of counterparts working together with the circular wedge faces, by which a friction lock is producible by twisting the shaft and hub in relation to one another. Furthermore, a rotational lock is provided for blocking and releasing the relative twisting of shaft and hub, the rotational lock being implemented to release the twisting at least in a predetermined shaft-hub position.

### CROSS REFERENCE TO RELATED APPLICATIONS

This application claims priority of German Patent Application DE 102005021833.4 filed May 11, 2005, the entire disclosure of which is incorporated herein by reference.

### FIELD OF THE INVENTION

The present invention relates to a shaft-hub connection and the use of a shaft-hub connection for fastening a grinding tool on a grinding tool driveshaft.

### BACKGROUND OF THE INVENTION

For the automated use of grinding tools, it is necessary to fasten them on the driveshaft of a motor. Producing such fastening by implementing a thread on the grinding tool and on the driveshaft is known. Alternatively, using nuts which may be screwed onto the shaft or similar fasteners for fastening the grinding tools is known.

The use of a thread on the grinding tool hub has the disadvantage that, as a function of the material used for producing the grinding tool main body, a thread may be milled into the main body only with significant effort or not at all. This may have the result that a further material layer must be applied, in which the thread is implemented. If fasteners are used for fastening the grinding tool on the shaft, additional components are required, which causes the construction of the shaft-hub connection to become more complex.

### SUMMARY OF THE INVENTION

Therefore, it is the object of the present invention to specify a shaft-hub connection for fastening a grinding tool on a grinding tool driveshaft, which may be produced and manufactured as simply as possible. This object is achieved by a shaft-hub connection, in which a number of circular wedge faces are provided on the peripheral surface of the shaft or on the internal surface of the grinding tool hub, and a number of counterparts working together with the circular wedge faces are provided on the other of the two components, a friction lock between shaft and hub being producible by twisting the shaft and the hub in relation to one another. Furthermore, a rotational lock for blocking and releasing the relative twisting of shaft and hub is provided, the rotational lock being implemented to release twisting at least at a predetermined shaft-hub position.

A number of circular wedges are implemented on the shaft or the hub based on a circular-cylindrical basic shape. An expediently equal number of counterparts working together with the circular wedges are implemented on the other of the two components. The shaft and the grinding tool hub are joined with play. The play is first removed by relative twisting of both parts in relation to one another after the joining, upon further twisting, the connection is produced as a friction lock by building up a contact pressure. The slope of the circular wedge faces is preferably designed in such a way that self-locking of the shaft-hub connection is ensured. The counterparts are preferably also implemented as circular wedge faces. The counterpart circular wedge faces especially preferably essentially correspond in their shape to the circular wedge faces, because in this way they may be clamped especially well against one another, so that the connection thus becomes even more secure. Fundamentally, however, other implementation forms of the counterparts are also possible, for example, a rib-like implementation. A shaft-hub connection of this type may be manufactured easily and does not require any additional parts besides the shaft and the hub. The circular wedge faces and the counterparts on the shaft or the hub are expediently manufactured by milling or other suitable processing methods, so that shaft and hub may each be implemented in one piece and no additional coatings or material layers are required. Furthermore, a connection of this type is operationally secure, because the torque of the shaft may be transmitted to the grinding tool without slip.

To ensure that the grinding tool is securely fastened on the shaft and the shaft torque is transmittable optimally to the grinding tool, a rotational lock is additionally provided, by which the relative twisting of shaft and hub may be blocked and/or released. Furthermore, the rotational lock is implemented to release the twisting at least at a predetermined shaft-hub position. A predetermined shaft-hub position is understood as a position of the shaft in which the shaft is inserted into the hub by a previously determined longitudinal dimension. The term shaft-hub position thus relates to the location of the shaft in the hub in relation to its axial direction. Because twisting is only released in predetermined shaft-hub positions, it is ensured that the connection by friction lock is only produced in those positions in which the torque is transmitted optimally and secure operation of the grinding device is ensured. In the shaft-hub position, the shaft is preferably inserted into the hub over the entire length of the hub and terminates approximately flush with the hub. Because the shaft is inserted into the hub in the axial direction over the entire hub length, the friction lock area between shaft and hub is maximized, by which the stability of the connection is improved. In addition, the security of the connection is further increased, because tilting of the grinding tool in relation to the shaft during grinding operation, as may occur if the shaft is only partially inserted into the hub, is avoided.

In a preferred embodiment of the present invention, the rotational lock is implemented as an interacting lug-groove configuration. The lug is either situated on the shaft or the hub and the groove is accordingly situated on the other component. In this way, secure blocking of the twisting may be achieved in a way which is easily producible, as long as the shaft is not located in the predetermined shaft-hub position. The groove is expediently implemented approximately coaxially to the shaft axis. The location of the shaft-hub position is determined by the length of the groove. It is expedient to situate a recess directly adjoining the groove, which is implemented in such a way that the lug is freely movable in the recess during the twisting of shaft and hub in relation to one another and the twisting is thus not blocked. The lug is preferably situated on the free end of the shaft. The lug releases the shaft for twisting as soon as the shaft is guided completely through the hub and its free end, including the lug, leaves the hub again. Therefore, the shaft part having a lug is in the shaft-hub position outside the hub and no recess for the ability to twist the lug has to be implemented in the hub. Furthermore, the groove may be implemented as continuous, which simplifies the manufacturing of the shaft and the hub. Moreover, due to its location outside the hub, the lug acts as an additional lock mechanism in the fixed state of the shaft-hub connection against shifting of the grinding tool in axial direction, by which the security of the connection is further improved.

To be able to determine the shaft-hub position upon insertion of the shaft into the hub more easily, it is expedient to implement a stop on the shaft and a stop face on the hub working together therewith. The stop is situated in such a way that it hits the stop face of the hub when the shaft is in the shaft-hub position. The handling is thus improved and it is ensured that the shaft-hub connection is always produced exactly in the optimal shaft-hub position. The stop is implemented as a peripheral ring seated on the shaft. However, any other suitable implementation is also fundamentally applicable.

In a further preferred embodiment, the hub is implemented having peripheral play in relation to the shaft in the axial direction in its end area which faces toward the shaft before shaft and hub are joined and/or the shaft is implemented having peripheral play in relation to the hub in the area of its free end. The shaft and/or the hub are especially preferably implemented in these areas as smooth circular cylinders, whose diameter is selected in such a way that the shaft is freely rotatable in the hub in this area. In this way, the shaft is insertable into the hub without prior centering of the circular wedge faces and the counterparts to one another. The centering only has to be performed when the shaft has already been partially inserted into the hub and the circular wedge faces and the counterparts of the shaft and hub impact one another on their fronts. Because the shaft is already partially inserted into the hub during the centering procedure, i.e., a guide of the shaft is provided, the joining of the shaft and hub may be performed more rapidly and the grinding tool changing procedure is simplified overall. Furthermore, the changing procedure of the grinding tools becomes more operationally secure, because, for example, slipping of the grinding tool off of the shaft during centering is avoided by the guide provided.

The circular wedge faces and the counterparts preferably extend along the shaft and/or the hub. A longitudinally axial orientation has the advantage that the insertion of the shaft into the hub is thus made easier and thus the production of the shaft-hub connection is simplified. Fundamentally, the circular wedge faces and the counterparts may be situated at arbitrary points of the shaft and the hub in the axial direction. Implementation over the entire length of the hub and/or the shaft is preferred, however, with the exception of those areas which are implemented having peripheral play. In this way, on one hand, the stability of the shaft-hub connection is increased and, on the other hand, flexibility is provided for the use of the grinding tools, because they may be attached at various points of the driveshaft. Multiple grinding tools may also thus be situated on one shaft.

Fundamentally, the circular wedge faces may be situated arbitrarily in the radial direction. A peripheral configuration is preferred, i.e., one circular wedge face directly adjoins the next, so that the entire external face of the shaft or internal face of the hub is occupied around the circumference with circular wedge faces. It is advantageous in this case that the friction lock between hub and shaft is distributed uniformly around the shaft or hub internal circumference, and a secure connection may thus be ensured. This effect is reinforced further in a preferred embodiment in which the circular wedge faces are implemented as essentially dimensionally identical (i.e., identical length, identical width, identical thickness, identical slope of the circular wedge faces, etc.). Three circular wedge faces having identical shapes are especially preferably distributed situated around the circumference of the shaft or the hub. This implementation simplifies the centering of shaft and hub.

The shaft-hub connection is expediently implemented as removable to allow changing of the grinding tools on the shaft. However, a nonremovable connection is also fundamentally possible. Whether a connection is removable or nonremovable results from the materials used for the shaft and the hub, the implementation of the circular wedge faces (e.g., steepness, size, etc.) and the size of the force which is applied during fixing of the shaft-hub connection.

In a further preferred embodiment of the present invention, the shaft-hub connection is oriented in such a way that the drive rotational direction of the grinding tool driveshaft corresponds to the direction in which the shaft is rotated in relation to the hub upon fixing of the connection. In this way, a danger of loosening of the connection during the grinding operation is avoided. During grinding, the grinding tool is braked in relation to the shaft by contact with the surface to be ground. Because the drive rotational direction corresponds to the shaft rotational direction during fixing, the wedging between shaft and hub is even further reinforced in this way. Loosening of the connection during the grinding operation is not possible. By this self-fixing of the shaft-hub connection during the grinding operation, it is also possible to dispense with prior fixing of shaft and hub, which further simplifies the handling.

In a further preferred embodiment, the grinding tool is produced from natural fiber composite material. This material is particularly suitable for use for grinding tools. Furthermore, in this embodiment, an annular or cylindrical insert is provided, in which the hub is implemented. The insert is manufactured from metal or pressure-resistant plastic. It is ensured by this metal or plastic insert that the hub withstands continuous strains. Whether the insert is implemented as annular or cylindrical is a function of the length of the hub in axial direction. The insert is permanently connected to the grinding tool, preferably using gluing and/or pressing. In principle, it is also possible to produce the shaft from material reinforced with natural fibers. If another material is used for the manufacture of the grinding tool, which has sufficient strength in relation to the forces acting on the hub, the use of an insert may fundamentally be dispensed with and the hub may be molded directly in the main body of the grinding tool.

The shaft-hub connection is fundamentally usable for all grinding tools known from the prior art. The grinding tool is preferably a grinding disk or a grinding roll.

The object is also achieved by the use of a shaft-hub connection for fastening a grinding tool on a grinding tool driveshaft, a number of circular wedge faces being provided on the peripheral surface of the shaft or on the internal surface of the grinding tool hub and a number of counterparts working together with the circular wedge faces being provided on the other of the two components, and a friction lock between shaft and hub being producible by twisting the shaft and hub in relation to one another. The mounting and dismounting of the grinding tools on the shaft is thus simplified and the handling is therefore improved overall.

### BRIEF DESCRIPTION OF THE DRAWINGS

In the following, the present invention is described further on the basis of an exemplary embodiment illustrated in the drawing.

FIG. 1 schematically shows a sectional side view of a grinding disk and a grinding tool driveshaft;

FIG. 2 schematically shows a perspective illustration in partial section of a grinding tool driveshaft having a grinding roll fastened thereon;

FIG. 3a schematically shows a side view of the hub of the grinding roll from FIG. 2 having a free end of the shaft from FIG. 2 inserted therein; and

FIG. 3b schematically shows the figure from FIG. 3a, the circular wedge faces of the shaft and the hub engaging in one another.

### DETAILED DESCRIPTION

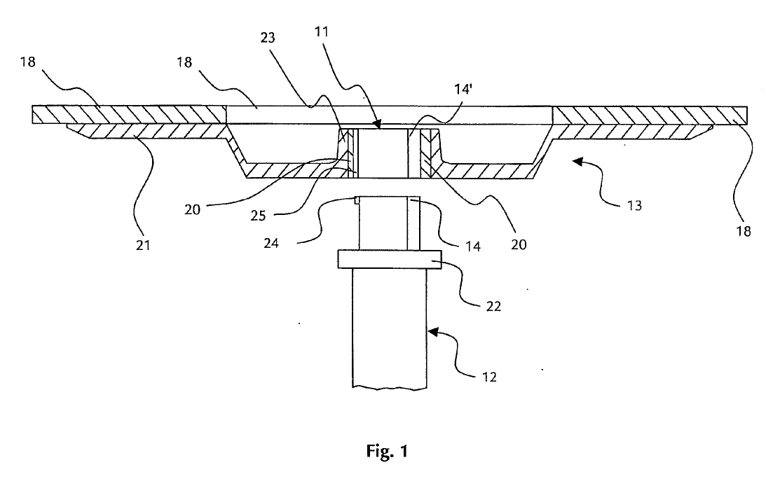

FIG. 1 shows a sectional side view of a grinding tool 13 implemented as a grinding disk. The grinding disk comprises a support plate 21, on which peripheral grinding lamellae 18 rest. The grinding lamellae 18 are fasten to the support plate 21 using a suitable adhesive. The lamellae 18 project beyond the outer edge of the support plate 21. They are situated in a fan shape and radially around a central hub 11. The inner area of the support plate 21 is implemented like a pot, the inner edge area 23 of the support plate 21 bulging upward around the central hub 11, so that the hub 11 extends over almost the entire height of the support plate 11.

A hollow cylindrical insert 20 is situated around the hub 11, on whose internal surface the internal surface of the hub is molded. The insert 20 is manufactured from pressure-resistant plastic, for example, and is pressed with the edge area 23 of the support plate 21 on its exterior side using a suitable adhesive. The internal surface of the hub 11 is provided with counterparts 14′ implemented as circular wedge faces, which run coaxially over the length of the hub 11. In total, three circular wedge faces 14′ (not shown in their entirety here) are implemented on the internal surface of the hub 11, which are situated continuously one behind the other around the circumference.

Furthermore, a groove 25 running parallel to the longitudinal axis and over the entire hub length is implemented in the hub. The groove 25 is part of a rotational lock. The hub 11 is situated complementarily to a grinding tool driveshaft 12, which has three circular wedge faces 14. The circular wedge faces 14 are thus situated on the shaft and the counterparts 14′, which are implemented as complementarily shaped circular wedge faces, are situated on the hub. In principle, however, a reverse configuration is also possible. Furthermore, a laterally projecting lug 24 is situated on the free end of the shaft, which is implemented to work together with the groove 25 and forms the other part of the rotational lock.

Upon insertion of the shaft 12 into the hub 11, the shaft 12 is to be oriented in relation to the hub 11 in such a way that the lug 24 engages in the groove 25. As long as the lug 24 engages in the groove 25, the shaft-hub connection is secured against twisting. As soon as the shaft 12 is inserted far enough into the hub 11 so that it projects on top of the hub 11, the lug 24 is released and the shaft-hub connection may be blocked by twisting the shaft 12 and hub 11 in relation to one another. It is ensured by the rotational lock that the locking may first be performed when the shaft 12 passes entirely through the hub 11.

Furthermore, a stop 22 implemented as a peripheral, projecting ring is provided on the shaft 12. The stop 22 is situated on the shaft 12 in such a way that it hits the bottom side of the support plate 21 as soon as the lug 24 is released. The shaft 12 is thus always only inserted to a predetermined length into the hub 11 and the shaft-hub connection is always oriented exactly. After the insertion of the shaft 12 up to the stop 22, shaft 12 and hub 11 are twisted in relation to one another, to thus produce a friction lock. A rotational movement exerted by a rotating drive may thus be transmitted without slip via the shaft 12 to the grinding disk. The support plate 21 of the grinding disk is implemented from material reinforced by natural fibers. This makes the use of an insert 20 made of sufficiently pressure-resistant plastic necessary to implement the hub 11, because it is thus ensured that the hub is not damaged by the forces applied thereto. If the material of the support plate 21 is sufficiently pressure-resistant, the circular wedge faces 14 may be molded directly on the support plate, and a hollow cylindrical insert is not necessary.

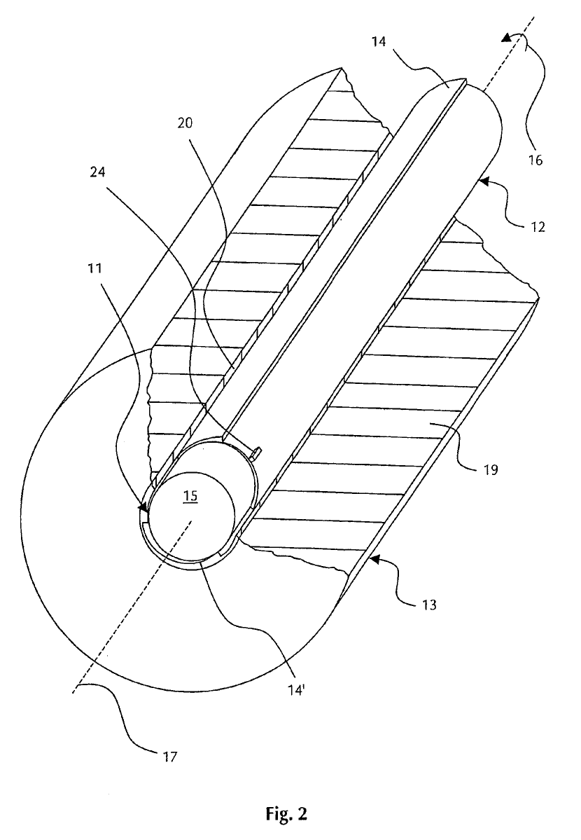

FIG. 2 shows a shaft-hub connection according to the present invention of a grinding tool driveshaft 12 and a grinding tool 13, which is implemented as a grinding roll. The shaft 12 has a free end 15, which is implemented as a circular cylinder having a smooth surface. The periphery of the circular cylinder is dimensioned in such a way that it is freely rotatable in the hub 11 of the grinding roll, which is provided on its internal surface with counterparts 14′ implemented as circular wedge faces. The free end 15 of the shaft 12 is situated in such a way that it terminates approximately flush with the grinding roll. The remainder of the shaft 12 is, like the hub 11, provided with axially running circular wedge faces 14. The circular wedge faces 14, 14′ of the shaft 12 and the hub 11 are implemented as essentially dimensionally identical and correspond to one another. Overall, both the shaft 12 and also the hub 11 thus have three peripherally situated circular wedge faces 14, 14′, which are situated continuously one behind another (see FIGS. 2a and 2b). The circular wedge faces 14′ of the hub 11 are implemented continuously in the axial direction.

A radially projecting lug 24 is implemented on one of the circular wedge faces 14 of the shaft 12 in the edge area at the free end 15 of the shaft 12. The lug 24 forms a rotational lock together with a groove (not shown here) implemented in the hub 11. In the position shown in FIG. 2, the shaft 12 is released for twisting. This is achieved in that a recess (not shown here) is provided in the area of the groove, in which the lug 24 may move freely upon twisting of the shaft 12 when the predetermined shaft-hub position is reached.

The hub 11 of the grinding roll is implemented in the internal surface of a hollow cylindrical insert 20, which is produced from pressure-resistant plastic, for example. The cylinder insert 20 is enclosed by a hollow-cylindrical grinding body 19. The grinding body 19 is produced, for example, from a hard textured nonwoven material. However, it may also have other grinding means, such as grinding lamellae. Fundamentally, the use of an insert 20 may be dispensed with and the hub 11 may be molded directly in the main body 19 if the material of the main body 19 has sufficient strength and damage to the hub 11 because of material failure may be precluded. The shaft 12 and the hub 11 of the grinding tool 13 are twisted in relation to one another so that a friction lock is provided between the shaft 12 and the hub 11. The shaft-hub connection is thus located in a fixed state in the illustration shown here. The arrow 16 indicates the drive rotation direction, in which the driveshaft 12 rotates around its longitudinal axis 17. The drive rotation direction 16 corresponds to the rotational direction of the shaft 12 upon fixing of the shaft-hub connection. In this way, the shaft-hub connection may not loosen during the grinding procedure.

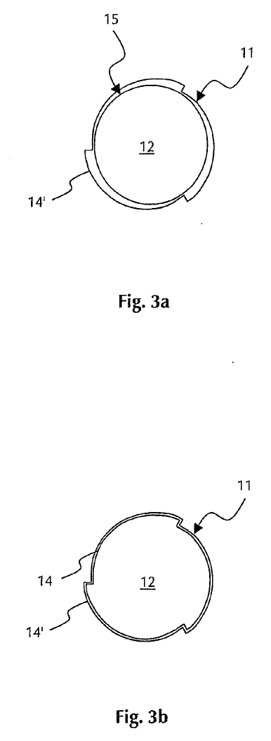

FIG. 3a shows a side view of the hub 11 from FIG. 2, into which the free end 15 of the shaft 12 implemented as a circular cylinder is inserted. The free end 15 is implemented having peripheral play in relation to the hub 11 and is thus insertable into the hub 11 in any arbitrary attitude. It may be rotated freely in the hub 11.

FIG. 3b shows the hub 11 having inserted shaft 12, the circular wedge faces 14′ of the hub 11 and the circular wedge faces 14 of the shaft 12 engaging in one another. The hub 11 and the shaft 12 are joined having play. In the illustration shown in FIG. 3b, the shaft 12 is in the centered state and may be displaced freely along its longitudinal axis 17. A friction lock may be produced between the shaft 12 and the hub 11 by relative twisting of the shaft 12 and the hub 11 to one another.

What is claimed is:

1. A shaft-hub connection for fastening a grinding tool on a grinding tool driveshaft, wherein a number of circular wedge faces are provided on the peripheral surface of the shaft or on the internal surface of the grinding tool hub and a number of counterparts working together with the circular wedge faces are provided on the other of the two components, a friction lock is producible between shaft and hub by twisting the shaft and hub in relation to one another, and a rotational lock is provided for blocking and releasing the relative twisting of shaft and hub, the rotational lock being implemented to release the twisting at least in a predetermined shaft-hub position.

2. The shaft-hub connection according to claim 1, wherein the counterparts are also implemented as circular wedge faces.

3. The shaft-hub connection according to claim 1, wherein the free end of the shaft terminates flush with the hub in the predetermined shaft-hub position.

4. The shaft-hub connection according to claim 1, wherein the rotational lock comprises a lug and a groove corresponding with the lug, one component being situated on the shaft and the other component being situated on the hub.

5. The shaft-hub connection according to claim 4, wherein the lug is situated on the free end of the shaft.

6. The shaft-hub connection according to claim 1, wherein a stop is implemented on the shaft and a corresponding stop face is implemented on the hub for fixing the location of the predetermined shaft-hub position.

7. The shaft-hub connection according to claim 1, wherein the hub, viewed in the axial direction, is implemented having play in relation to the shaft in its end area, which faces toward the shaft before the joining of shaft and hub, and/or the shaft is implemented as having peripheral play in relation to the hub in the area of its free end.

8. The shaft-hub connection according to one of claim 7, wherein the shaft and the hub each have three essentially dimensionally identical circular wedge faces.

9. The shaft-hub connection according to claim 1, wherein the drive rotation direction of the driveshaft corresponds to the shaft rotational direction upon producing the friction lock.

10. The shaft-hub connection according to claim 1, wherein the grinding tool is essentially manufactured from natural fiber material, the hub being formed by an annular or cylindrical insert, which is manufactured from metal or plastic.

11. The shaft-hub connection according to claim 1, wherein the grinding tool is a grinding disk or a grinding roll.

12. A use of a shaft-hub connection for fastening a grinding tool on a grinding tool driveshaft, a number of circular wedge faces being provided on the peripheral surface of the shaft or on the internal surface of the grinding tool hub and a number of counterparts working together with the circular wedge faces being provided on the other of the two components, by which a friction lock is producible between shaft and hub upon twisting of the shaft and hub in relation to one another.

13. The use according to claim 12, wherein the grinding tool is situated on the shaft in such a way that the drive rotational direction of the shaft corresponds to the rotational direction in which the shaft is rotated upon production of the friction lock between shaft and hub.
